(19) United States
(12) Patent Application Publication
(10) Pub. No.: US 2019/0305621 A1
(43) Pub. Date: Oct. 3, 2019

(54) WOUND COIL, COIL FOR ELECTRICAL ROTATING MACHINE, ELECTRICAL ROTATING MACHINE, METHOD FOR MANUFACTURING WOUND COIL, AND APPARATUS FOR MANUFACTURING WOUND COIL

(71) Applicant: HONDA MOTOR CO., LTD., Tokyo (JP)

(72) Inventors: Keiichiro Oka, Tochigi (JP); Kazuhito Hiraga, Tochigi (JP); Kenichi Omagari, Tochigi (JP)

(21) Appl. No.: 16/362,898

(22) Filed: Mar. 25, 2019

(30) Foreign Application Priority Data
Mar. 28, 2018 (JP) 2018-061205

(51) Int. Cl. H02K 3/12; H02K 1/16; H02K 3/48; H02K 15/04

(52) U.S. Cl. CPC H02K 3/12; H02K 15/0464; H02K 3/48; H02K 1/16

(57) ABSTRACT

The wound coil (7) includes first to fourth inner bases (11a) to (11d), first to fourth outer bases (12a) to (12d). The wound coil (7) includes first to fourth upper connection portions (16a) to (16d), first to third lower connection portions (17a) to (17c), and first to fourth winding portions (18a) to (18d). In the first to fourth winding portions (18a) to (18d), the third and fourth upper connection portions (16c) and (16d) are stacked on the first and second upper connection portions (16a) and (16b) in the circumferential direction D1 and the first and third lower connection portions (17a) and (17c) are continuously stacked on the second lower connection portion (17b) in the circumferential direction D1.

### BACKGROUND OF THE INVENTION

### Field of the Invention

The present invention refers to a wound coil, a coil for an electrical rotating machine, an electrical rotating machine, a method for manufacturing the wound coil, and an apparatus for manufacturing the wound coil.

### Description of the Related Art

An electrical rotating machine such as an electric motor and an electric generator includes a cylindrically formed stator and a rotor rotatably arranged inside the stator.

A leg of a U-shaped coil member is inserted into a slot provided on a stator core of the stator. The U-shaped coil member includes a pair of legs and a connecting part for connecting the pair of legs and the connecting part is bent in the shape of S (refer to Japanese Patent No. 3752431, for example). In the Japanese Patent No. 3752431, the coil member is stacked in the circumferential direction of the stator to form a lap wound coil.

In the case of forming the lap wound coil by stacking the coil member and bending, a portion of the lap would coil protruding from a slot in a circular shape, the amount of protrusion is increased, thereby increasing the size.

The present invention has been made in view of such circumstances and its object is to provide the wound coil that can be reduced in size, the coil for an electrical rotating machine, the electrical rotating machine, the method for manufacturing the wound coil, and the apparatus for manufacturing the wound coil.

### SUMMARY OF THE INVENTION

The wound coil according to the present invention is characterized in that a wound coil, the plurality of which are arranged in a circumferential direction of a stator core to form an annular coil inserted into a slot of the stator core for an electrical rotating machine, includes: a first base extending in an axis direction of the coil; a second base extending in the axis direction of the coil with the second base offset from the first base in each of a circumferential direction and a radial direction of the stator core; and a plurality of winding portions including an one-end connection portion which connects one end of the first base to one end of the second base; wherein the winding portions excluding one of the plurality of winding portions include other-end connection portions which connect other-end portion of the second base to other-end portion of the first base of the other winding portions, the plurality of winding portions are provided continuously such that respective one-end connection portions of the plurality of winding portions are stacked in the circumferential direction of the stator core and respective first base of the plurality of winding portions is arranged in the radial direction of the stator core and respective second base of the plurality of winding portions is arranged in the radial direction of the stator core.

According to the wound coil of the present invention, the one-end connection portions are stacked in the circumferential direction of the stator core, so that the wound coil can be made smaller than a conventional one in which the one-end connection portions are not stacked, in such a manner that the amount of protrusion extending to an axis direction of the coil at each connection portion is decreased. Short circumference of the coil enables a conductor resistance to be reduced. Furthermore, an increase in surface area of the connection portion protruded from the stator core improves a cooling efficiency.

The coil for an electrical rotating machine according to the present invention includes a plurality of the wound coils and is characterized in that the second base of the winding portion without the other-end connection portion of the wound coil is connected with the first base with which the other-end connection portion of the adjacent wound coil is not connected, and thereby the plurality of the wound coils are connected and annularly formed.

The coil for the electrical rotating machine according to the present invention is configured by a wound coil smaller than a conventional one to allow coil for the electrical rotating machine to be downsized.

The electrical rotating machine according to the present invention is characterized by including a coil for the electrical rotating machine and a stator formed in a cylindrical shape in which a plurality of slots, into which the plurality of the wound coils for the electrical rotating machine are inserted, are formed on an inner circumference surface.

According to the electrical rotating machine in the present invention, the electrical rotating machine is configured by the coil for an electrical rotating machine smaller than a conventional one to allow the electrical rotating machine to be downsized.

A method for manufacturing a wound coil according to the present invention, in which a plurality of which are arranged in a circumferential direction of a stator core and connected to form a ring-shaped coil inserted into a slot of the stator core for an electrical rotating machine, is characterized by including: a first step of: forming a plurality of winding portions, by bending a coil member, including a first base extending in an axis direction of the coil, a second base extending in the axis direction of the coil with the second base offset from the first base in at radial direction of the stator core, and an one-end connection portion which connects one end of the first base to one end of the second base; providing the winding portions excluding one of the plurality of winding portions with other end connection portion which connects the other end portion of the second base with the other end connection portion of the first base of the other winding portions; and continuously forming the plurality of the winding portions such that respective one-end connection portions of the plurality of the winding portions are stacked in the circumferential direction of the stator core and respective first base of the plurality of the winding portions are arranged in a radial direction of the stator core and respective second base of the plurality of the winding portions are arranged in the radial direction of the stator core; and a second step, performed after the first step, of bending respective first bases of the plurality of the winding portions and respective second bases of the plurality of the winding portions to mutually inverse direction in the circumferential direction of the stator core.

According to the method for manufacturing the wound coil in the present invention, the wound coil which is smaller in size than a conventional one can be manufactured.

An apparatus for manufacturing a wound coil according to the present invention, in which a plurality of which are arranged in a circumferential direction of a stator core and connected to form an annular coil inserted into a slot of the stator core for an electrical rotating machine includes: a first formation unit which forms: a plurality of winding portions, by bending a coil member, including a first base extending in an axis direction of the coil, a second base extending in the axis direction of the coil with the second base offset from the first base in a radial direction of the stator core, and an one-end connection portion which connects one end of the first base to one end of the second base; providing the winding portions excluding one of the plurality of winding portions with other end connection portion which connects the other end portion of the second base with the other end connection portion of the first base of the other winding portions; and continuously forming the plurality of the winding portions such that respective one-end connection portions of the plurality of the winding portions are stacked in the circumferential direction of the stator core and respective first base of the plurality of the winding portions are arranged in the radial direction of the stator core and respective second base of the plurality of the winding portions are arranged in the radial direction of the stator core; and a second formation unit, after formation by the first formation unit, which bends respective first bases of the plurality of the winding portions and respective second bases of the plurality of the winding portions to mutually inverse direction in the circumferential direction of the stator core.

According to the apparatus for manufacturing the wound coil in the present invention, the wound coil which is smaller in size than a conventional one can be manufactured.

### BRIEF DESCRIPTION OF THE DRAWINGS

FIG. 1 is a top view showing the wound coil according to one embodiment of the present invention and the stator on which the wound coil is mounted;

FIG. 2 is a perspective view showing the stator core and the lap wound coil;

FIG. 3 is a perspective view showing the lap wound coil;

FIG. 4 is a front view showing the lap wound coil;

FIG. 5 is a front view schematically showing the lap wound coil;

FIG. 6 is a block diagram showing the apparatus for manufacturing the lap wound coil; and

FIG. 7 shows a process for manufacturing the lap wound coil.

### DETAILED DESCRIPTION OF THE PREFERRED EMBODIMENTS

The following describes the coil for the electrical rotating machine according to one embodiment of the present invention with reference to the drawings.

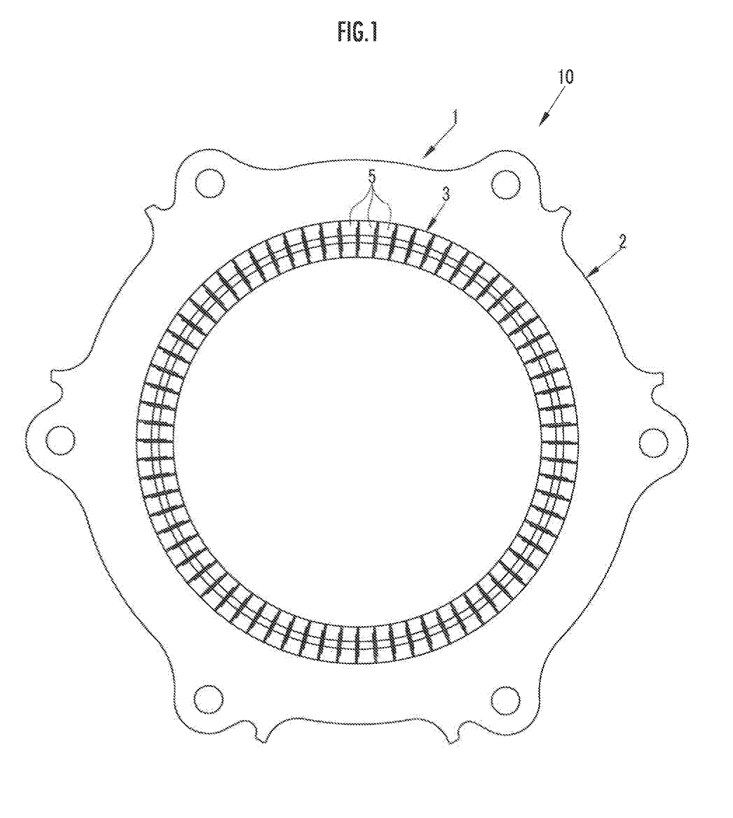

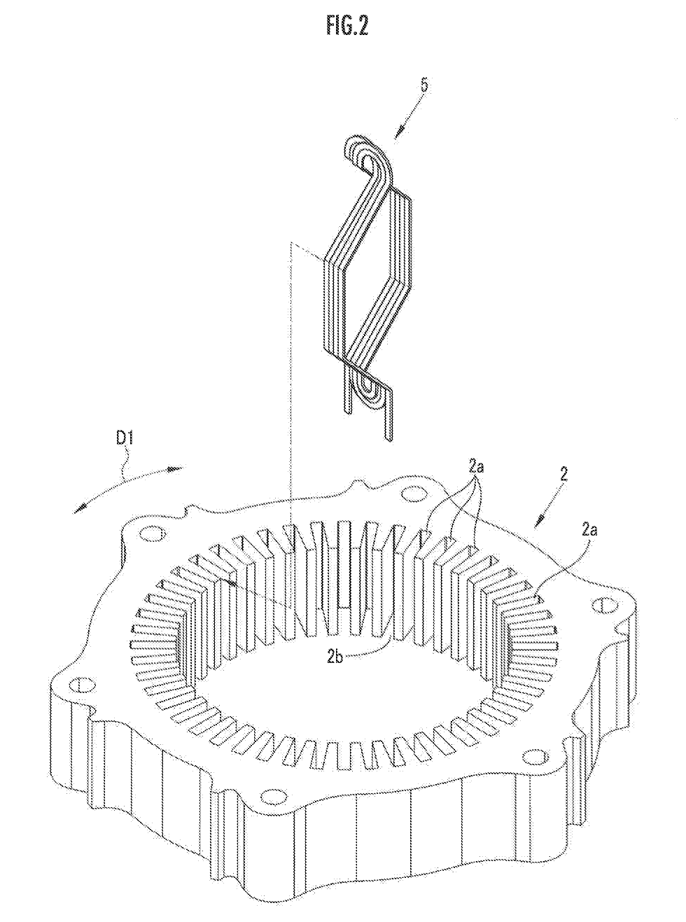

As shown in FIGS. 1 and 2, an electrical rotating machine 10 such as an electric motor and an electric generator includes a stator 1 formed in a cylindrical shape and a rotor (not shown) which is rotatably arranged inside of the stator 1.

The stator 1 includes a stator core 2 and a coil 3. The stator core 2 is cylindrical and a plurality of slots 2a penetrating in a rotation-axis direction are provided at a spaced interval in the circumferential direction. The coil 3 is provided with a plurality of the lap wound coils 5 arranged in the circumferential direction D1 of the coil 3.

In the present embodiment, the coil 3 is formed in an eight-layer structure in a radial direction D2 of the coil 3. The first, second, . . . and eighth layers are formed from the inner side to the outer side of the radial direction D2 of the coil 3.

The coil 3 of the present embodiment is a three-phase coil formed of U, Y, and W phases, and the lap wound coil 5 inserted into each slot 2a is arranged in the circumferential direction in order of U, U, V, V, W, and W phases.

[Lap Wound Coil]

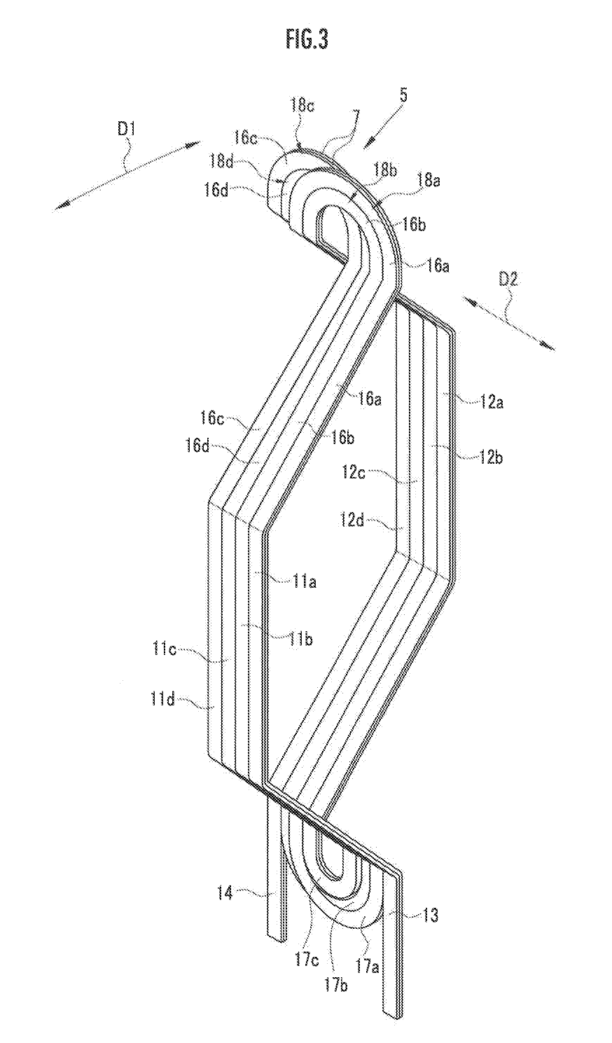

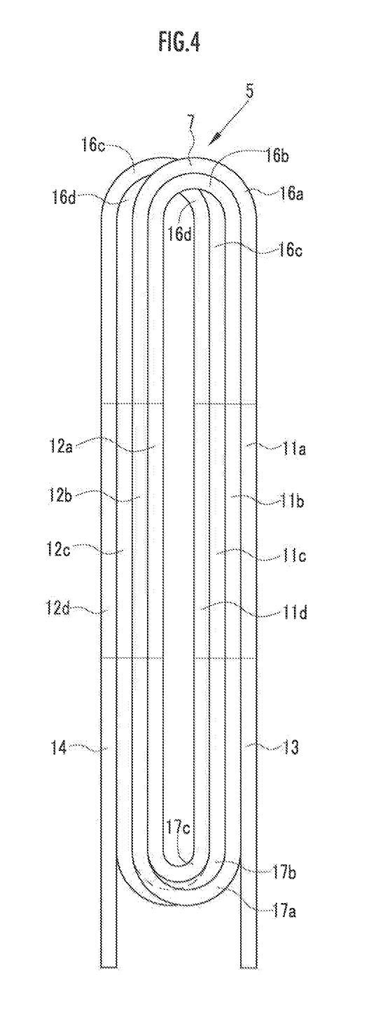

As shown in FIGS. 3 to 5, the lap wound coil 5 is such that a plurality of the wound coils 7 (two, for example) are superposed thereon. The wound coil 7 includes a first base with first to fourth inner bases 11a to 11d, a second base with first to fourth outer bases 12a to 12d, an inner lower end portion 13 connected with a lower end portion of the first inner base 11a, and an outer lower end portion 14 connected with a lower end portion of the fourth outer base 12d.

The first to fourth outer bases 12a to 12d are offset from the first to fourth inner bases 11a to 11d to each of the radial direction D2 and the circumferential direction D1 of the stator core 2.

The first to fourth inner bases 11a to 11d are bent to this side of the circumferential direction D1 and the first to fourth outer bases 12a to 12d are bent to the other side of the circumferential direction D1.

In a single lap wound coil 5, the first to fourth inner bases 11a to 11d are inserted into the inner circumferential portion of a predetermined slot 2a to form the first to fourth layers and the first to fourth outer bases 12a to 12d are inserted into the outer portion of the slot 2a spaced out by a predetermined distance from the predetermined slot 2a to form the fifth to eighth layers. The lap wound coils 5 are inserted into all the slots 2a to form a ring-shaped coil 3 and the adjacent lap wound coils 5 connect the inner lower end portion 13 with the outer lower end portion 14.

The wound coil 7 includes first to fourth upper connection portions 16a to 16d (one end connection portion). The first upper connection portion 16a connects the upper end of the first inner base 11a with the upper end of the second outer base 12b. The second upper connection portion 16b connects the upper end of the second inner base 11b with the upper end of the first outer base 12a.

The third upper connection portion 16c connects the upper end of the third inner base 11c with the upper end of the fourth outer base 12d. The fourth upper connection portion 16d connects the upper end of the fourth inner base 11d with the upper end of the third outer base 12c.

The wound coil 7 includes first to third lower connection portions 17a to 17c (another end connection portion). The first lower connection portion 17a connects the lower end of the second inner base 11b with the lower end of the second outer base 12b. The second lower connection portion 17b connects the lower end of the third inner base 11c with the lower end of the third outer base 12c. The third lower connection portion 17c connects the lower end of the fourth inner base 11d with the lower end of the first outer base 12a.

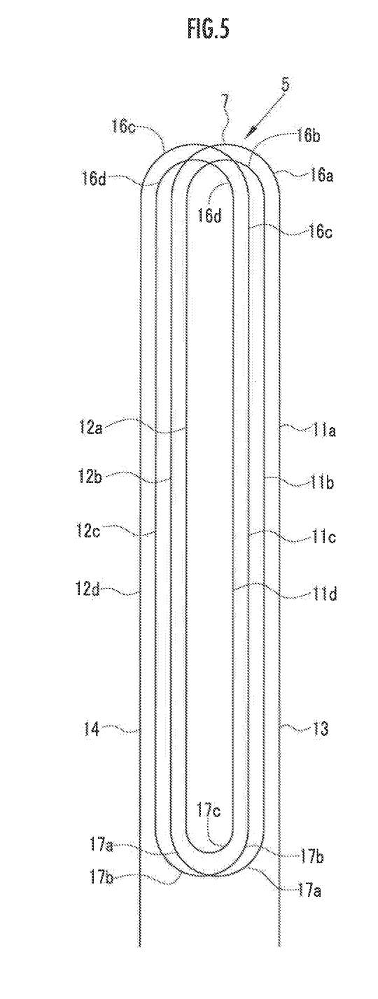

Circular arcs are formed at tip portions of upper and lower portions of the connection portions 16a to 16d and 17a to 17c. FIG. 5 shows portions 11a to 11d, 12a to 12d, 13, 14, 16a to 16d and 17a to 17c using lines whose widths are very small.

The wound coil 7 includes first to fourth winding portions 18a to 18d. The first winding portion 18a includes the first inner base 11a, the first upper connection portion 16a, the second outer base 12b, and the first lower connection portion 17a. The second winding portion 18b includes the second inner base 11b, the second upper connection portion 16b, the first outer base 12a, and the third lower connection portion 17c.

The third winding portion 18c includes the third inner base 11c, the third upper connection portion 16c, and the fourth outer base 12d. The fourth winding portion 18d includes the fourth inner base 11d, the fourth upper connection portion 16d, the third outer base 12c, and the second lower connection portion 17b.

The wound coil 7 is wound around from the first inner base 11a of the first winding portion 18a to the first lower connection portion 17a via the first upper connection portion 16a and the second outer base 12b. The terminal of the first lower connection portion 17a is connected with the proximal end (lower end) of the second inner base 11b of the second winding portion 18b.

The wound coil 7 is wound around from the second inner base 11b of the second winding portion 18b to the third lower connection portion 17c via the second upper connection portion 16b and the first outer base 12a. The terminal of the third lower connection portion 17c is connected with the proximal end (lower end) of the fourth inner base 11d of the fourth winding portion 18d.

The wound coil 7 is wound around from the fourth inner base 11d of the fourth winding portion 18d to the second lower connection portion 17b via the fourth upper connection portion 16d and the third outer base 12c. The terminal of the second lower connection portion 17b is connected with the proximal end (lower end) of the third inner base 11c of the third winding portion 18c.

In the first to fourth winding portions 18a to 18d, such a configuration causes the third and fourth upper connection portions 16c and 16d to lap on the first and second upper connection portions 16a and 16b, respectively, in the circumferential direction D1. Furthermore, the first to fourth winding portions 18a to 18d are continuously provided in such a manner that each of the first to fourth inner bases 11a to 11d is arranged in the radial direction D2 and each of the first to fourth outer bases 12a to 12d is arranged in the radial direction D2.

The amount of protrusion of the first and second upper connection portions 16a and 16b to the upper direction caused by respective circular arc portions is equal to the amount of two coils. Similarly, the amount of protrusion of the third and fourth upper connection portions 16c and 16d to the upper direction caused by respective circular arc portions is equal to the amount of two coils. More specifically, the amount of protrusion of the first to fourth upper connection portions 16a to 16d to the upper direction caused by respective circular arc portions is equal to the amount of two coils.

As is conventionally done, if the first to fourth upper connection portions 16a to 16d are stacked upward at the same position in the circumferential direction D1, the amount of protrusion of the first to fourth upper connection portions 16a to 16d to the upper direction caused by respective circular arc portions is equal to the amount of four coils.

In the present embodiment, the amount of protrusion of the first to fourth upper connection portions 16a to 16d to the upper direction caused by respective circular arc portions is made equal to the amount of two coils, which enables the amount of protrusion to be smaller than ever before. This allows the lap wound coil 5, the coil 3, and an electrical rotating machine 10 to be downsized. The circumferential length (entire length) of the wound coil 7 can be smaller than ever before, which allows a conductor resistance to be reduced. Furthermore, the surface area of the connection portion protruding from the stator core 2 (areas of inner and outer circumference surfaces) is larger than ever before, which allows a cooling efficiency to be improved.

Furthermore, in the present embodiment, the third and fourth upper connection portions 16c and 16d are bent to be displaced to the circumferential direction D1 with respect to the first and second upper connection portions 16a and 16b. Therefore, in the present embodiment, a lap wound coil 5 formed such that the wound coil 7 is stacked makes the wound coil 7 more difficult to be disintegrated than a convention one which is produced such that the first to fourth upper connection portions 16a to 16d are stacked upward. This enables workability to be improved in working with the lap wound coil 5 held.

Similarly, the second lower connection portion 17b is bent to be displaced to the circumferential direction D1 with respect to the first and third lower connection portions 17a and 17c, which enables the amount of protrusion of the first to third lower connection portions 17a to 17c caused by respective circular arc portions to be smaller than before.

As described in the above configuration, the wound coil 7 is configured such that the first inner base 11a, the first upper connection portion 16a, the second outer base 12b, the first lower connection portion 17a, the second inner base 11b, the second upper connection portion 16b, the first outer base 12a, the third lower connection portion 17c, the fourth inner base 11d, the fourth upper connection portion 16d, the third outer base 12c, the second lower connection portion 17b, the third inner base 11c, the third upper connection portion 16c, and the first outer base 12a are connected in this order.

[Lap Wound Coil Manufacturing Apparatus]

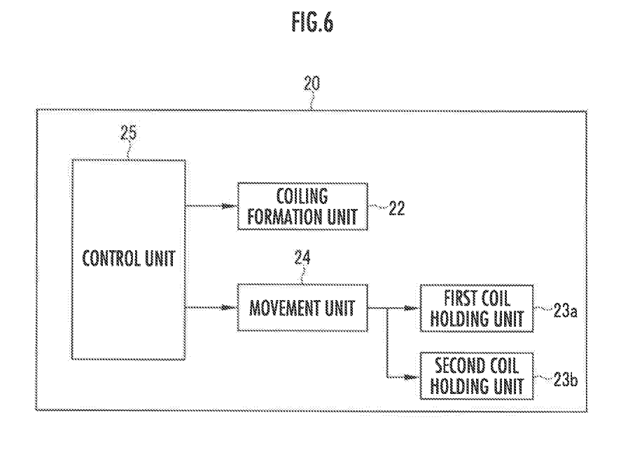

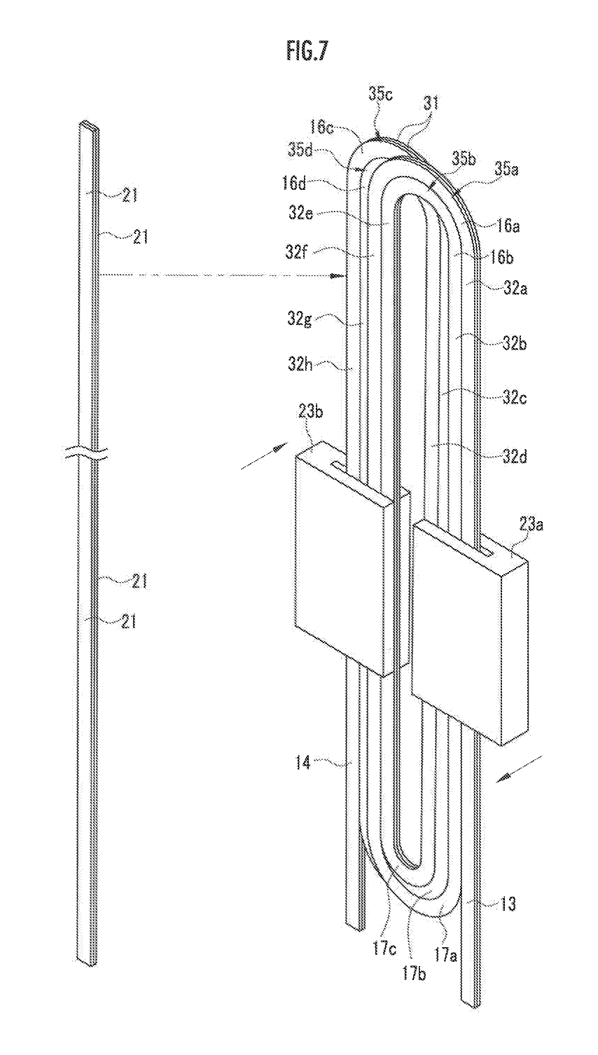

As shown in FIG. 6, a lap wound coil manufacturing apparatus 20 in the present invention manufactures the lap wound coil 5 (refer to FIG. 3) such that a liner coil member 21 (refer to FIG. 7) is bent and includes a coiling formation unit 22 (first formation unit) for coiling the liner coil member 21 first formation unit and first and second coil holding units 23a and 23b for holding the coil member 21.

The lap wound coil manufacturing apparatus 20 includes a movement unit 24 for moving the first and second coil holding units 23a and 23b and a control unit 25 for generally controlling the lap wound coil manufacturing apparatus 20. The coiling formation unit 22 and the movement unit 24 are controlled by the control unit 25.

[Method for Manufacturing the Lap Wound Coil]

As shown in FIG. 7, at the time of manufacturing the lap wound coil 5 by the lap wound coil manufacturing apparatus 20, two liner coil members 21 are stacked. The coiling formation unit 22 performs coiling with the ends of two coil members 21 held (for example, the coiling formation unit 22 wraps the coil members 21 around a winding jig). Two coil members 21 are wound (bent) to form two wound coil 31 (first step). At this point, connection portions 16a to 16d and 17a to 17c on the wound coil 7 are formed.

The wound coil 31 includes the first to fourth linear bases 32a to 32d and the fifth to eighth linear bases 32e to 32h, the first to fourth upper connection portions 16a to 16d, the first to third lower connection portions 17a to 17c, an inner lower end portion 13, and an outer lower end portion 14.

In the wound coil 31, the first upper connection portion 16a connects the upper end portion of the first base 32a to the upper end portion of the sixth base 32f. The second upper connection portion 16b connects the upper end portion of the second base 32b to the upper end portion of the fifth base 32e.

The third upper connection portion 16c connects the upper end portion of the third base 32c to the upper end portion of the eighth base 32h. The fourth upper connection portion 16d connects the upper end portion of the fourth base 32d to the upper end portion of the seventh base 32g.

The first lower connection portion 17a connects the lower end portion of the second base 32b to the lower end portion of the sixth base 32f. The second lower connection portion 17b connects the lower end portion of the third base 32c to the lower end portion of the seventh base 32g. The third lower connection portion 17c connects the lower end portion of the fourth base 32d to the lower end portion of the fifth base 32e.

The wound coil 31 includes first to fourth wound portions 35a to 35d. The first wound portion 35a includes the first base 32a (first base), the first upper connection portion 16a, the sixth base 32f(second base), and the first lower connection portion 17a. The second wound portion 35b includes the second base 32b (first base), the second upper connection portion 16b, the fifth base 32e (second base), and the third lower connection portion 17c.

The third wound portion 35c includes the third base 32c (third base), the third upper connection portion 16c, and the eighth base 32h (fourth base). The fourth wound portion 35d includes the fourth base 32d (first base), the fourth upper connection portion 16d, the seventh base 32g (second base), and the second lower connection portion 17b.

Two wound coils 31 are formed, thereafter, the first coil holding unit 23a holds the first to fourth bases 32a to 32d of respective two wound coils 31, and the second coil holding unit 23b holds the fifth to eighth bases 32e to 32h of respective two wound coils 31.

The control unit 25 drives the movement unit 24 to move the first coil holding unit 23a to the side which is nearer the observer in the figure and move the second coil holding unit 23b to the back side of the figure. This movement bends the first to fourth bases 32a to 32d to the side which is nearer the observer and bends the fifth to eighth bases 32e to 32h to the back side (the second step). In the present embodiment, the second formation unit includes the first and second coil holding units 23a and 23b, and the movement unit 24.

The above steps, as shown in FIG. 3, produce the lap wound coil 5 in which two wound coils 7 are stacked.

[Vehicle]

The electrical rotating machine 10 can be mounted on a vehicle such as an electric automobile and a hybrid automobile. The electrical rotating machine 10 is used as a driving source or a power production source. As described above, the electrical rotating machine 10 can be made smaller than a conventional one, which can increase a space for installing members except the electrical rotating machine 10 in the vehicle, and thereby the freedom of layout can be improved.

In the above embodiment, the lap wound coil 5 in which two wound coils 7 are stacked is produced, however, the number of the wound coil 7 can be appropriately changed, so that a single wound coil 7 can be produced or a lap wound coil in which three or more wound coils 7 are stacked can be produced.

What is claimed is:

1. A wound coil, a plurality of which are arranged in a circumferential direction of a stator core to form an annular coil inserted into a slot of the stator core for an electrical rotating machine, comprising:
a first base extending in an axis direction of the coil;
a second base extending in the axis direction of the coil with the second base offset from the first base in each of a circumferential direction and a radial direction of the stator core; and
a plurality of winding portions including an one-end connection portion which connects one end of the first base to one end of the second base;
wherein, the winding portions excluding one of the plurality of winding portions include other-end connection portions which connect other-end portion of the second base to other-end portion of the first base of the other winding portions,
the plurality of winding portions are provided continuously such that respective one-end connection portions of the plurality of winding portions are stacked in the circumferential direction of the stator core and respective first base of the plurality of winding portions is arranged in the radial direction of the stator core and respective second base of the plurality of winding portions is arranged in the radial direction of the stator core.

2. A coil for an electrical rotating machine including a plurality of the wound coils according to claim 1, wherein the second base of the winding portion without the other-end connection portion of the wound coil is connected with the first base with which the other-end connection portion of the adjacent wound coil is not connected, and thereby the plurality of the wound coils are connected and annularly formed.

3. An electrical rotating machine comprising:
a coil for the electrical rotating machine according to claim 2; and
a stator formed in a cylindrical shape in which a plurality of slots, into which the plurality of the wound coils for the electrical rotating machine are inserted, are formed on an inner circumference surface.

4. A method for manufacturing a wound coil, in which a plurality of which are arranged in a circumferential direction of a stator core and connected to form an annular coil inserted into a slot of the stator core for an electrical rotating machine comprising:
a first step of: forming a plurality of winding portions, by bending a coil member, including a first base extending in an axis direction of the coil, a second base extending in an axis direction of the coil with the second base offset from the first base in a radial direction of the stator core, and an one-end connection portion for connecting one end of the first base to one end of the second base; providing the winding portions excluding one of the plurality of winding portions with other end connection portion for connecting the other end portion of the second base with the other end connection portion of the first base of the other winding portions; and continuously forming the plurality of the winding portions such that respective one-end connection portions of the plurality of the winding portions are stacked in the circumferential direction of the stator core and respective first base of the plurality of the winding portions are arranged in the radial direction of the stator core and respective second base of the plurality of the winding portions are arranged in the radial direction of the stator core; and
a second step, performed after the first step, of bending respective first bases of the plurality of the winding portions and respective second bases of the plurality of the winding portions to mutually inverse direction in the circumferential direction of the stator core.

5. An apparatus for manufacturing a wound coil, in which a plurality of which are arranged in a circumferential direction of a stator core and connected to form an annular coil inserted into a slot of the stator core for an electrical rotating machine, comprising:
a first formation unit which forms: a plurality of winding portions, by bending a coil member, including a first base extending in an axis direction of the coil, a second base extending in the axis direction of the coil with the second base offset from the first base in a radial direction of the stator core, and an one-end connection portion which connects one end of the first base to one end of the second base; providing the winding portions excluding one of the plurality of winding portions with other end connection portions which connect the other end portion of the second base with the other end connection portion of the first base of the other winding portions; and continuously forming the plurality of the winding portions such that respective one-end connection portions of the plurality of the winding portions are stacked in the circumferential direction of the stator core and respective first base of the plurality of the winding portions are arranged in the radial direction of the stator core and respective second base of the plurality of the winding portions are arranged in the radial direction of the stator core; and
a second formation unit, after formation by the first formation unit, which bends respective first bases of the plurality of the winding portions and respective second bases of the plurality of the winding portions to mutually inverse direction in the circumferential direction of the stator core.
